(19) United States
(12) Patent Application Publication
(10) Pub. No.: US 2012/0087021 A1
(43) Pub. Date: Apr. 12, 2012

(54) MOVING DEVICE

(76) Inventors: Chih-Ta CHIEN, Taipei (TW); Chien-Hsin Lu, Taipei (TW)

(21) Appl. No.: 12/951,825

(22) Filed: Nov. 22, 2010

(30) Foreign Application Priority Data
Oct. 11, 2010 (TW) 099134627

(51) Int. Cl. G02B 7/02

(52) U.S. Cl. 359/817

(57) ABSTRACT

A moving device is disclosed. The moving device includes a first lens barrel, a second lens barrel, a shutter module, a pushing lever, a flexible element, and a third lens barrel. The first lens barrel includes an upper edge and a groove which is at the upper edge. The second lens barrel is sleeved within the first lens barrel. The shutter module is disposed on the second lens barrel. The pushing lever includes a first end and a second end which is fixed within the groove of the first lens barrel. The flexible element is disposed besides the pushing lever for pushing the pushing lever. The third lens barrel is sleeved outside the first lens barrel. The third lens barrel includes a convex block. When the first lens barrel, the second lens barrel, and the third lens barrel are extending, the flexible element pushes the pushing lever for enclosing the pushing lever within the groove of the first lens barrel; when the first lens barrel, the second lens barrel, and the third lens barrel are stowing, the convex block pushes the pushing lever out of the groove of the first lens barrel.

### BACKGROUND OF THE INVENTION

1. Field of the Invention

The present invention generally relates to a moving device, and more particularly to a moving device which is applied in a picture capturing device.

2. Description of the Prior Art

With advances in technology, the magnification of the lens device of the digital product, such as a digital camera or a digital video camera, has become higher gradually. Thus, the thickness of the lens in the stowing state is also increased. However, since the digital product has become smaller, the thickness of the lens device in the stowing state should be decreased so as to make the lens device be suitable for the small digital product.

When the conventional lens device is stowing, the lens module or the shutter module is generally moved by the structure of the main body disposed near the bottom of the lens device. However, the design method mentioned above can not be applied in some situations. For example, when the main body near the bottom of the lens device is weak, it is difficult to form the structure which is capable of moving the lens module or the shutter module. Moreover, when the space near the bottom of the lens device is small, it is also difficult to form the structure which is capable of moving the lens module or the shutter module.

For the reason that there are some disadvantages of the prior art mentioned above, there is a need existed to propose a moving device so as to meet consumer needs.

### SUMMARY OF THE INVENTION

Accordingly, the present invention has been made in order to meet such a need described above, and it is an object of the present invention to provide a moving device so as to meet consumer needs.

In order to achieve the above object, the present invention provides a moving device. The moving device includes a first lens barrel, a second lens barrel, a shutter module, a pushing lever, a flexible element, and a third lens barrel. The first lens barrel includes an upper edge and a groove which is at the upper edge. The second lens barrel is sleeved within the first lens barrel. The shutter module is disposed on the second lens barrel. The pushing lever includes a first end and a second end which is fixed within the groove of the first lens barrel. The flexible element is disposed besides the pushing lever for pushing the pushing lever. The third lens barrel is sleeved outside the first lens barrel. The third lens barrel includes a convex block. When the first lens barrel, the second lens barrel, and the third lens barrel are extending, the flexible element pushes the pushing lever for enclosing the pushing lever within the groove of the first lens barrel; when the first lens barrel, the second lens barrel, and the third lens barrel are stowing, the convex block pushes the pushing lever out of the groove of the first lens barrel.

### BRIEF DESCRIPTION OF THE DRAWINGS

FIG. 1 shows the exploded view of a moving device in accordance with an embodiment of the present invention; and

FIG. 2A and FIG. 2B show the operation method of the moving device.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

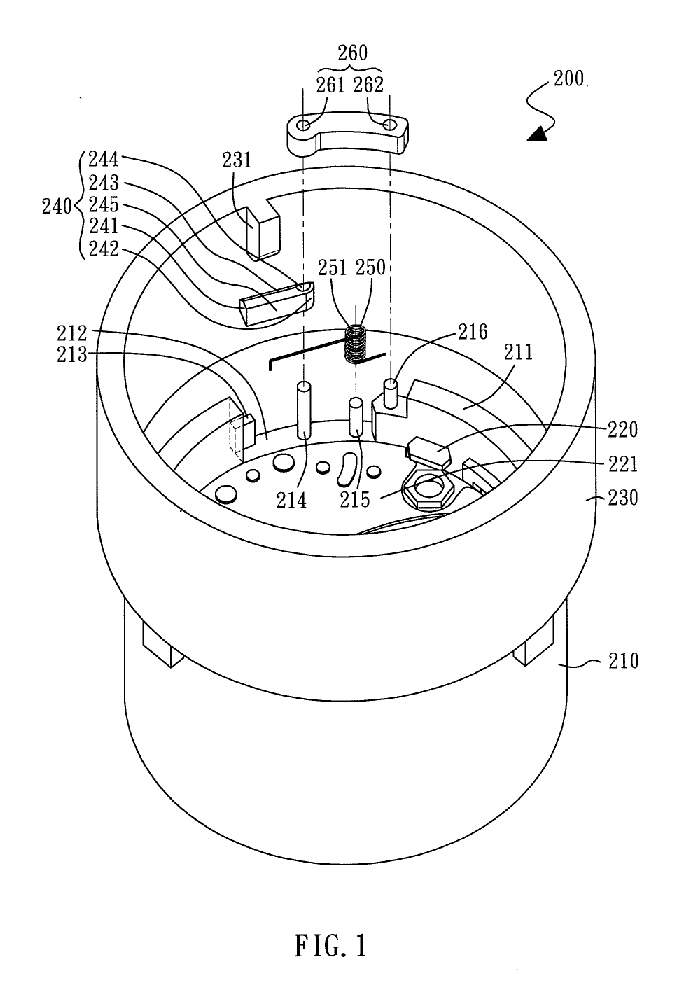

FIG. 1 shows the exploded view of a moving device 200 in accordance with an embodiment of the present invention. The moving device 200 includes a first lens barrel 210, a second lens barrel 220, a shutter module 221, a pushing lever 240, a flexible element 250, and a third lens barrel 230. The first lens barrel 210 includes an upper edge 211 and a groove 212 which is at the upper edge 211. The second lens barrel 220 is sleeved within the first lens barrel 210. The shutter module 221 is disposed on the second lens barrel 220. The pushing lever 240 includes a first end 241 and a second end 242 which is fixed within the groove 212 of the first lens barrel 210. The flexible element 250 is disposed besides the pushing lever 240 for pushing the side wall 245 of the pushing lever 240. The third lens barrel 230 is sleeved outside the first lens barrel 210. The third lens barrel 230 includes a convex block 231.

In this embodiment, the moving device 200 can further include a fixing block 260 so as to fix the pushing lever 240 and the flexible element 250 within the groove 212. Moreover, according to this embodiment, the groove 212 of the first lens barrel 210 can include a first positioning column 214, a second positioning column 215, and a third positioning column 216. The second end 242 of the pushing lever 240 has a first hole 244. The first positioning column 214 passes through the first hole 244 of the pushing lever 240. By using the first positioning column 214 as an axis, the pushing lever 240 is capable of rotating within the groove 212 of the first lens barrel 210. The second positioning column 215 passes through an inner opening 251 of the flexible element 250. By using the second positioning column 215 as an axis, the flexible element 250 is capable of rotating within the groove 212 of the first lens barrel 210. The fixing block 260 has a second hole 261 and a third hole 262. The first positioning column 214 and the third positioning column 216 pass through the second hole 261 and the third hole 262 respectively so as to fix the pushing lever 240 and the flexible element 250 within the groove 212. But not limited to the design mentioned above, the moving device 200 can be other design.

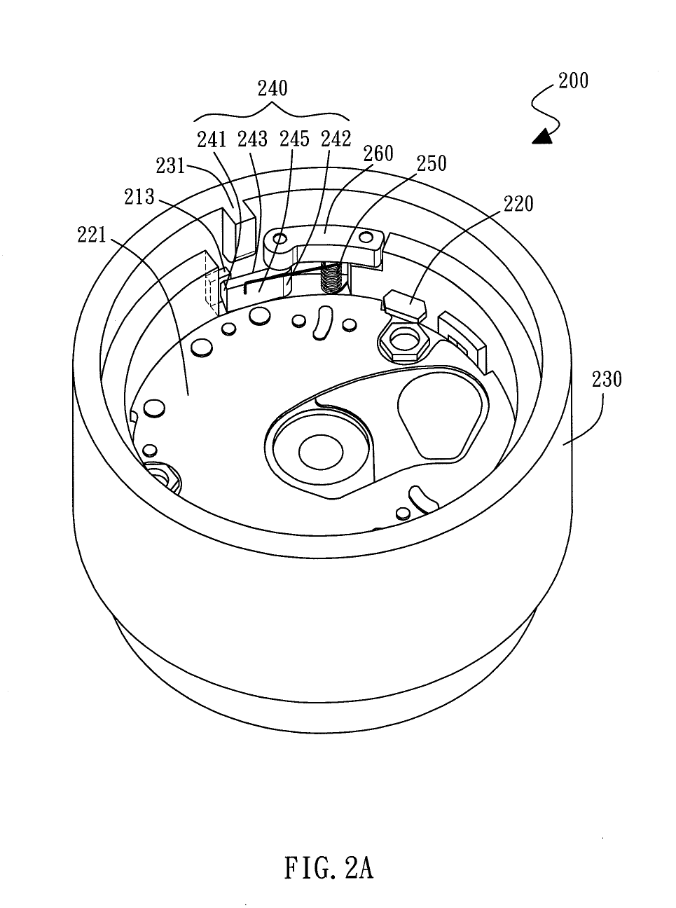

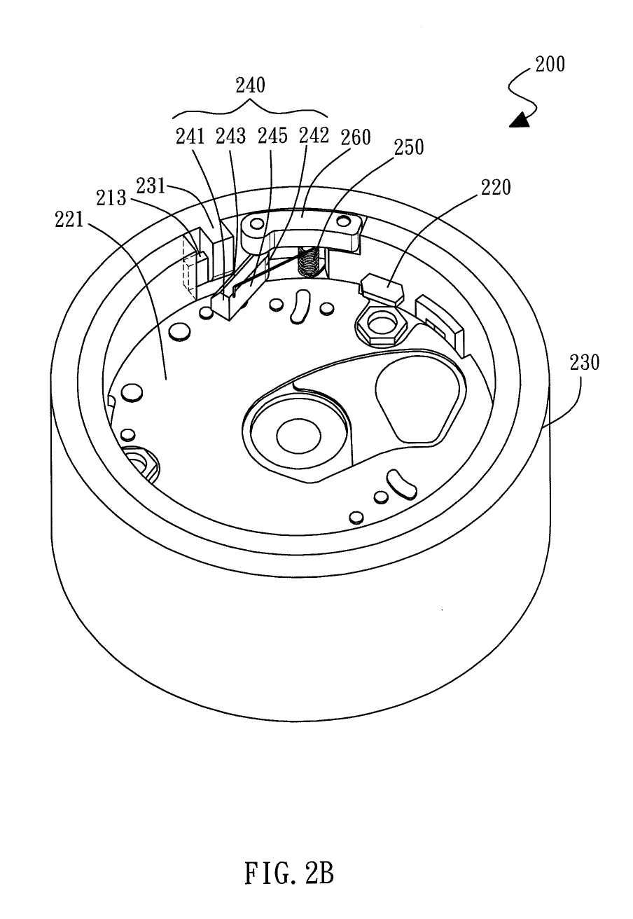

FIG. 2A and FIG. 2B show the operation method of the moving device 200. Referring to FIG. 2A, when the first lens barrel 210, the second lens barrel 220, and the third lens barrel 230 are extending, the flexible element 250 pushes the pushing lever 240 for enclosing the pushing lever 240 within the groove 211 of the first lens barrel 210. In this situation, the second lens barrel 220 and the shutter module 221 disposed on the second lens barrel 220 are capable of moving along the first lens barrel 210. The pushing lever 240 does not contact the shutter module 221.

In this embodiment, the first lens barrel 210 includes a positioning block 213. The positioning block 213 is disposed within the groove 212 of the first lens barrel 210. The flexible element 250 pushes the pushing lever 240 so as to make the pushing lever 240 contact the positioning block 213 closely. The positioning block 213 is used for controlling the position of the pushing lever 240 within the groove 212. Moreover, according to this embodiment, the flexible element 250 is a torsion spring, but not limited to this. The flexible element 250 can be other flexible element.

Referring to FIG. 2B, when the first lens barrel 210, the second lens barrel 220, and the third lens barrel 230 are stowing, the third lens barrel 230 moves relative to the first lens barrel 210. The convex block 231 pushes the pushing lever 240 out of the groove 212 of the first lens barrel 210 so as to make the first end 241 of the pushing lever 240 contact the shutter module 221. Thus, the shutter module 221 is moved with the first lens barrel 210, and the thickness of the lens device in the stowing state is decreased. According to this embodiment, the pushing lever 240 includes an inclined plane 241. In the stowing process mentioned above, the third lens barrel 230 moves relative to the first lens barrel 210. The convex block 231 contacts the inclined plane 241 and pushes the pushing lever 240 out of the groove 212. But not limited to this, the convex block 231 and the pushing lever 240 can be other design. For example, an inclined plane can be disposed on the convex block 231, and the pushing lever 240 is pushed out of the groove 212 by the inclined plane of the convex block 231.

In this embodiment, the moving device 200 includes only one pushing lever 240. The pushing lever 240 is capable of contacting the shutter module 221 for decreasing the thickness of the lens device in the stowing state. But not limited to this, the moving device 200 can include a plurality of pushing levers 240. The pushing levers 240 are disposed within a plurality of grooves 212 of the first lens barrel 210 respectively. A plurality of flexible elements 250 is disposed besides the pushing levers 240 respectively. The third lens barrel 230 includes a plurality of convex blocks 231. When the first lens barrel 210, the second lens barrel 220, and the third lens barrel 230 are extending, the flexible elements 250 push the pushing levers 240 respectively for enclosing the pushing levers 240 within the grooves 212 of the first lens barrel 210. When the first lens barrel 210, the second lens barrel 220, and the third lens barrel 230 are stowing, the convex blocks 231 push the pushing levers 240 out of the grooves 212 of the first lens barrel 210. In this situation, the pushing levers 240 contact the shutter module 221 together. Thus, the shutter module 221 is pushed by the pushing levers 240 equally. The thickness of the lens device in the stowing state is decreased.

By the design mentioned above, the third lens barrel 230 moves relative to the first lens barrel 210 in the stowing process. The convex block 231 contacts the inclined plane 241 and pushes the pushing lever 240 out of the groove 212. Thus, the shutter module 221 is pushed by the pushing lever 240, and the thickness of the lens device in the stowing state is decreased. There is no need for the moving device 200 to use the structure disposed near the bottom of the lens device to move the shutter module 221 for decreasing the thickness of the lens device in the stowing state. Therefore, the design mentioned above can be applied in the situation that the main body near the bottom of the lens device is weak. Besides, the design mentioned above can also be applied in the situation that the space near the bottom of the lens device is small.

Moreover, the space near the bottom of the lens device can be used for disposing other device. It is also helpful to decrease the volume of the camera. Therefore, the camera having the moving device 200 can have smaller volume. The moving device 200 is suitable for the small digital product.

Although specific embodiments have been illustrated and described, it will be appreciated by those skilled in the art that various modifications may be made without departing from the scope of the present invention, which is intended to be limited solely by the appended claims.

What is claimed is:

1. A moving device, comprising:
a first lens barrel, said first lens barrel comprising an upper edge and a groove which is at said upper edge;
a second lens barrel, said second lens barrel being sleeved within said first lens barrel;
a pushing lever, said pushing lever comprising a first end and a second end which is fixed within said groove of said first lens barrel;
a flexible element, said flexible element being disposed besides said pushing lever for pushing said pushing lever; and
a third lens barrel, said third lens barrel is sleeved outside said first lens barrel, said third lens barrel comprising a convex block, wherein when said first lens barrel, said second lens barrel, and said third lens barrel are extending, said flexible element pushes said pushing lever for enclosing said pushing lever within said groove of said first lens barrel; when said first lens barrel, said second lens barrel, and said third lens barrel are stowing, said convex block pushes said pushing lever out of said groove of said first lens barrel.

2. The moving device according to claim 1, wherein when said first lens barrel, said second lens barrel, and said third lens barrel are stowing, said third lens barrel moves relative to said first lens barrel, and said convex block pushes said pushing lever out of said groove.

3. The moving device according to claim 1, further comprising a shutter module which is disposed on said second lens barrel.

4. The moving device according to claim 3, wherein when said convex block pushes said pushing lever out of said groove, said first end of said pushing lever pushes said shutter module.

5. The moving device according to claim 4, wherein said pushing lever comprises an inclined plane, said convex block pushes said pushing lever out of said groove by contacting said inclined plane.

6. The moving device according to claim 4, wherein said first lens barrel further comprises a positioning block, said positioning block is disposed within said groove of said first lens barrel, said flexible element pushes said pushing lever so as to make said pushing lever contact said positioning block closely.

7. The moving device according to claim 1, wherein said groove of said first lens barrel further comprises a first positioning column, said pushing lever is capable of rotating within said groove of said first lens barrel with the aid of said first positioning column.

8. The moving device according to claim 1, wherein said first lens barrel further comprises a second positioning column, said flexible element is capable of rotating on said first lens barrel with the aid of said second positioning column.

9. The moving device according to claim 1, further comprising a fixing block, said first lens barrel further comprising a third positioning column, wherein said third positioning column passes through said fixing block.

10. A moving device, comprising:
a first lens barrel, said first lens barrel comprising an upper edge and a plurality of grooves which are at said upper edge;
a second lens barrel, said second lens barrel being sleeved within said first lens barrel;
a shutter module, said shutter module being disposed on said second lens barrel;
a plurality of pushing levers, said pushing levers being disposed within said grooves of said first lens barrel respectively;
a plurality of flexible elements, said flexible elements being disposed besides said pushing levers respectively for pushing said pushing levers; and
a third lens barrel, said third lens barrel is sleeved outside said first lens barrel, said third lens barrel comprising a plurality of convex blocks, wherein when said first lens barrel, said second lens barrel, and said third lens barrel are extending, said flexible elements push said pushing levers for enclosing said pushing levers within said grooves of said first lens barrel; when said first lens barrel, said second lens barrel, and said third lens barrel are stowing, said convex blocks push said pushing levers out of said grooves of said first lens barrel.

11. The moving device according to claim 10, wherein when said first lens barrel, said second lens barrel, and said third lens barrel are stowing, said third lens barrel moves relative to said first lens barrel, and said convex block pushes said pushing lever out of said groove.

12. The moving device according to claim 10, wherein when said convex block pushes said pushing lever out of said groove, said first end of said pushing lever pushes said shutter module.

13. The moving device according to claim 10, wherein said pushing lever comprises an inclined plane, said convex block pushes said pushing lever out of said groove by contacting said inclined plane.

14. The moving device according to claim 10, wherein said first lens barrel further comprises a positioning block, said positioning block is disposed within said groove of said first lens barrel, said flexible element pushes said pushing lever so as to make said pushing lever contact said positioning block closely.

15. The moving device according to claim 10, wherein said groove of said first lens barrel further comprises a first positioning column, said pushing lever is capable of rotating within said groove of said first lens barrel with the aid of said first positioning column.

16. The moving device according to claim 10, wherein said first lens barrel further comprises a second positioning column, said flexible element is capable of rotating on said first lens barrel with the aid of said second positioning column.

17. The moving device according to claim 10, further comprising a fixing block, said first lens barrel further comprising a third positioning column, wherein said third positioning column passes through said fixing block.
